(19) United States
(12) Patent Application Publication
(10) Pub. No.: US 2015/0001330 A1
(43) Pub. Date: Jan. 1, 2015

(54) DEVICE FOR POSITIONING OR STABILISING A LOAD ATTACHED TO A CRANE

(71) Applicant: Joseph O'Kane, Edinburgh (GB)

(72) Inventor: Joseph O'Kane, Edinburgh (GB)

(21) Appl. No.: 13/701,680

(22) PCT Filed: Apr. 26, 2011
(86) PCT No.: PCT/GB2011/050817

§ 371 Date: Aug. 11, 2014

(30) Foreign Application Priority Data
Jun. 4, 2010 (GB) 1009358.1

(51) Int. Cl. B66C 13/04; B66D 3/18

(52) U.S. Cl. CPC B66C 13/04; B66D 3/18
USPC 242/396

(57) ABSTRACT

There is herein described a device and method for positioning a load (18) attached to apparatus (10) capable of lifting and moving loads in suspension. More particularly, there is described a device and method for safely positioning a suspended load (18) attached to a crane hook (16).

### FIELD OF THE INVENTION

The present invention relates to a device and method for positioning or stabilizing a load attached to apparatus capable of lifting and moving suspended loads. More particularly, the present invention relates to a device and method for safely positioning a suspended load attached to a crane hook.

### BACKGROUND OF THE INVENTION

Cranes are commonly used in a range of industries to lift and move heavy loads. For example, cranes can be found on ship docks and in the construction industry.

During the lifting and moving of heavy loads it has been the standard practice to attach a simple cord to the bottom of a load to allow a workman to maneuver the position of the load. These cords are commonly referred to as ‘tag lines’. However, there are a number of disadvantages and dangers associated with the use of tag lines. The tag lines can easily become wrapped around a workman attempting to maneuver the load which can be extremely dangerous as the workman can then accidentally be lifted by the crane movements with serious injuries occurring. When a load is lowered this can also result in a large amount of slack in the tag line with this simply lying on the ground. With a large amount of slack tag line lying on the ground this can easily become entangled with other articles and with the workman maneuvering the load on the crane. The slack tag line can also become entangled with other workmen in the near vicinity who may accidentally walk over the tag line.

It is an object of at least one aspect of the present invention to obviate or mitigate at least one or more of the aforementioned problems.

It is a further object of at least one aspect of the present invention to provide an improved device and method for positioning a load attached to apparatus capable of lifting and moving suspended loads.

It is a further object of at least one aspect of the present invention to provide an improved device and method for safely positioning a suspended load attached to a crane hook.

### SUMMARY OF THE INVENTION

According to a first aspect of the present invention there is provided a device for positioning a load attached to apparatus capable of lifting and moving suspended loads, said device comprising:

a reel comprising a rotatable member;

a leash located around the rotatable member and attachable to the load,

wherein the leash located around the rotatable member is retractable.

The leash may be attached to the load being lifted using any suitable mechanical means. For example, the leash may be attached to a lower (e.g. bottom) surface of the load by being threaded through an opening (e.g. an eyelet) in the lower surface of the load.

The leash may be any type of flexible arrangement such as a cable, cord, rope, wire, chain, tape, mesh and the like which is capable of being located around the rotatable member.

At the end of the leash there may be means for attaching the leash to the load to be maneuvered. The means for attachment may, for example, be an eyelet, hook, clamp or suction cup. The attachment means may be removable from the end of the leash. A range of attachment means may be provided.

The leash may be of any suitable length and may, for example, be about 1-20 m in length.

The reel comprising the rotatable member may comprise retraction means. The retraction means may be spring-loaded so that any slack in the leash may be removed and a certain degree of tension may therefore be maintained in the leash during use. This overcomes the danger of any slack leash lying on the ground and any slack leash wrapping around the operator during use. However, in the event that the tension in the leash extends beyond a certain level so that an operator may accidentally be lifted off the ground then there may be a mechanism in the reel to release the tension in the leash. The mechanism may comprise a normally activated but releasable brake.

The reel may comprise a handle through which the leash may be controlled during use. A brake release operating member may be provided at the handle, such as at a position corresponding to a user's palm. The device may be configured such that normal holding of the handle releases the brake.

A second operating member may be provided at the handle. The second operating member may be configured to act against the brake release operating member such that the brake is actuated even when the device is being held. By pressing on the second operating member the leash may be held securely held and locked in position. The handle may also comprise a thumb lock to fix the leash in place for an extended period.

The leash located around the rotatable member may be retractable using any suitable means. The retraction may also be automatic. However, to control the speed and/or rate of retraction the reel may comprise a second brake, such as a friction brake, and/or a damper mechanism to avoid retraction occurring too quickly.

To assist in use the leash may be coloured and/or fluorescent.

The present invention therefore relates to a retractable leash which is capable of being attached to a suspended load. An operator can maneuver the position of the suspended load on the lifting apparatus (e.g. a crane) by pulling the leash in a particular direction. This not only allows easy maneuvering but is also very safe as there is no slack in the leash.

According to a second aspect of the present invention there is provided a method of positioning a load attached to apparatus capable of lifting and moving suspended loads, said method comprising:

providing a reel comprising a rotatable member;

providing a leash located around the rotatable member;

wherein the leash located around the rotatable member is retractable and the leash can be moved by an operator to position the load.

The method of positioning a load may use the device as defined in the first aspect.

According to a third aspect of the present invention there is provided a crane lifting a load attached to a device as defined in the first aspect.

### BRIEF DESCRIPTION OF THE DRAWINGS

Embodiments of the present invention will now be described, by way of example only, with reference to the accompanying drawing in which:

FIG. 1 is a diagrammatic representation of a device in use for safely positioning a suspended load attached to a crane hook; and

FIG. 2 is an embodiment of the device of FIG. 1.

### BRIEF DESCRIPTION

Generally speaking, the present invention resides in the provision of a device and method for positioning a suspended load attached to apparatus capable of lifting and moving loads.

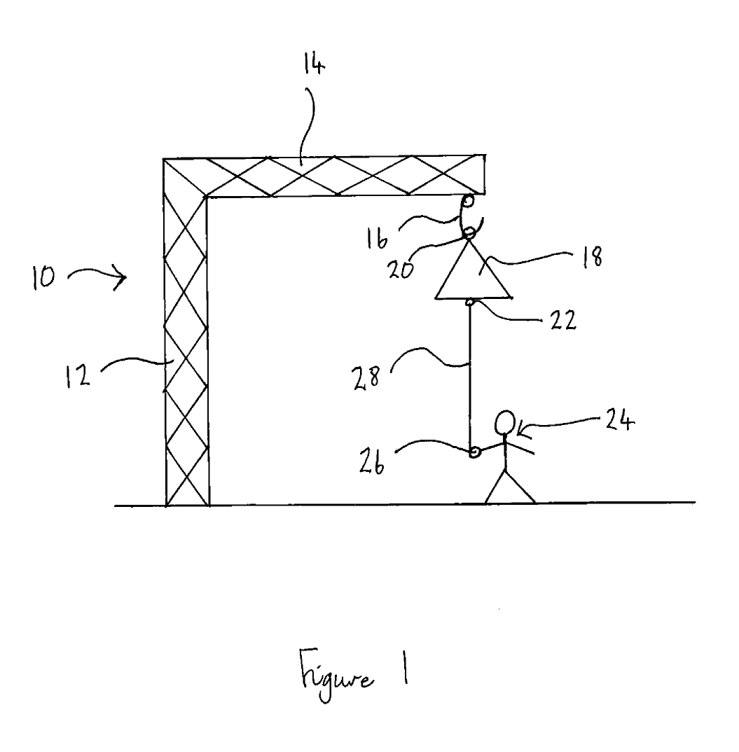

FIG. 1 is a representation of a device according to the present invention. FIG. 1 shows that there is a crane, generally designated 10. The crane comprises a substantially vertical member 12 and a substantially horizontal member 14. Located at an end of the substantially horizontal member 14 there is a hook 16. The hook 16 is inserted through an opening 20 on top of a load 18 being lifted by the crane 10.

Below the load 18 there is shown an operator 24. The operator 24 is holding a device according to the present invention. The device is shown to comprise a reel 26 and a retractable leash 28. The reel 26 is spring-activated and is shown to tension the leash 28 so that there is no slack. Although not shown the device also comprises a handle and thumb lock which can be used to securely hold the leash in place.

In use, the load 18 will be lifted by the crane 10 until the leash 28 can be safely attached to the load. Usually the leash 28 is attached to a lower surface of the load 18 such as through an eyelet 22. The load 18 can then be raised further if necessary to a desired height. As the load 18 is raised more of the leash 28 will be retracted from the reel 26. Once the leash 28 reaches the desired length then the reel 26 which is spring-activated will keep the leash taught so that no slack is present. The brake can be operated to hold the leash 28 and the operator 24 can then pull the leash 28 in a required direction to easily maneuver and position the suspended load 18. A thumb-lock 30 may be used to lock the leash 28 in place. During use if the length of the leash 28 changes then more leash 28 can be extended from the reel 26. Alternatively, if less leash 28 is required then as some slack temporarily occurs then this will automatically be retracted into the reel 26 using the spring-activated means.

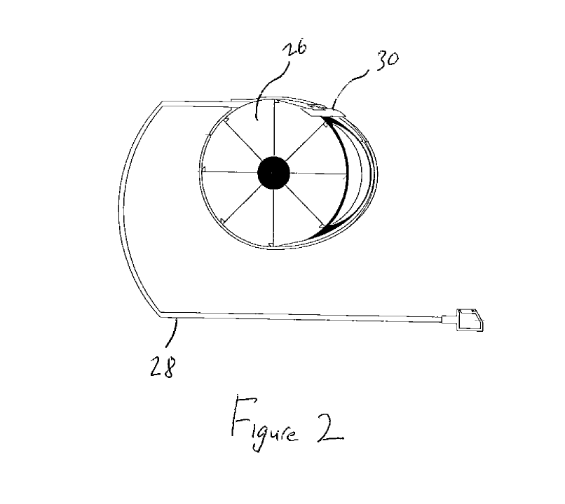

FIG. 2 shows an embodiment of the device.

Whilst specific embodiments of the present invention have been described above, it will be appreciated that departures from the described embodiments may still fall within the scope of the present invention. For example, any suitable type of retractable leash may be used. Moreover, any suitable type of retraction means may be used to retract and extend the leash.

1. A device for positioning a load attached to apparatus capable of lifting and moving suspended loads, said device comprising:
a reel comprising a rotatable member;
a leash located around the rotatable member; and
wherein the leash located around the rotatable member is retractable.

2. A device according to claim 1, wherein the leash is attached to the load being lifted using a mechanical connector.

3. A device according to claim 1, wherein the leash is attached to the load by a removable connector.

4. A device according to claim 1, wherein the leash comprises at least one of: a cable, cord, rope, wire, chain, tape, or mesh.

5. A device according to claim 1, including a range of removable attachment means.

6. A device according to claim 1, wherein the leash has a length of from approximately 1 m to approximately 20 m.

7. A device according to claim 1, wherein the reel comprising the rotatable member comprises retraction means capable of retracting or extending the length of the leash.

8. A device according to claim 7, wherein the retraction means is spring-loaded so that any slack in the leash is capable of being removed such that a tension is maintained in the leash during use.

9. A device according to claim 1, wherein the reel comprises a handle through which the leash is capable of being controlled during use, and wherein by pressing an operating member provided at the handle the leash is capable of being held securely in position using a mechanical arrangement to abut against the leash and securely hold it in place.

10. A device according to claim 1, including a normally activated brake for fixing the leash in place which is releasable by operating an operating member.

11. A device according to claim 9, wherein the handle comprises a thumb lock capable of fixing the leash in place.

12. A device according to claim 1, wherein the leash located around the rotatable member is capable of being automatically retracted and/or extended.

13. A device according to claim 1, wherein, to control at least one of the speed and rate of retraction, the reel comprises at least one of a brake and a damper mechanism to avoid retraction occurring too quickly.

14. A device according to claim 1, wherein the leash is at least one of colored and fluorescent.

15. A method of positioning a load attached to apparatus capable of lifting and moving suspended loads, said method comprising:
providing a reel comprising a rotatable member;
providing a leash located around the rotatable member; and
wherein the leash located around the rotatable member is retractable and the leash can be moved by an operator to position the load.

16. (canceled)

17. (canceled)

18. (canceled)

19. A method of positioning a load attached to a crane capable of lifting and moving the load, said method comprising the steps of:
providing a load having attached thereto device comprising a leash disposed on a reel, the leash being selectively extendible from, and retractable onto, the reel; and
moving the load from a first position to a second position with the crane, during which movement step an operator pulls on the leash to manually position the load.

20. The method of claim 19, wherein the reel is spring-loaded so that any slack in the leash between the load and the reel is removable by automatically retracting the leash onto the reel.

21. The method of claim 20, wherein the device comprises at least one of a brake and a damper mechanism to limit the rate at which the leash is automatically retracted onto the reel.

22. The method of claim 21, wherein the device includes a normally activated brake for fixing the leash in place on the reel.

23. The method of claim 22, wherein the reel includes a handle through which the leash is capable of being controlled during use, and wherein further the brake is selectively releasable by a manually actuated operating member provided at the handle.
